(19) United States
(12) Patent Application Publication
(10) Pub. No.: US 2005/0276914 A1
(43) Pub. Date: Dec. 15, 2005

(54) Method for manufacturing light guide plate mold cores

(76) Inventors: Ming-Dah Liu, Miao-Li County (TW); Shu-Chi Hou, Miao-Li County (TW)

Correspondence Address: BIRCH STEWART KOLASCH & BIRCH, PO BOX 747, FALLS CHURCH, VA, 22040-0747, US

(21) Appl. No.: 10/866,661

(22) Filed: Jun. 15, 2004

(51) Int. Cl. B05D 1/00; C25D 5/02

(52) U.S. Cl. 427/133; 205/118

(57) ABSTRACT

A method for manufacturing light guide plate mold cores to form a precise pattern on a light guide mold core to produce light guide plates for back light modules. The method includes forming a metal layer of a selected pattern by a micro lithography process that has varying heights, and plating a layer of non-electrolyzed nickel (nickel-phosphorus alloy) to form the surface of the light guide plate mold core. The mold core thus formed, has a smooth surface, a desired mold releasing property and is durable.

### FIELD OF THE INVENTION

The present invention relates to a method for manufacturing light guide plate mold cores and more particularly to a method for manufacturing light guide plate mold cores with desired surface characteristics through a non-printing approach.

### BACKGROUND OF THE INVENTION

The present methods for manufacturing light guide plate can be divided into a printing approach and a non-printing approach. The printing approach dispenses a printing material that has high light emitting characteristics such as SiO₂ and TiO₂ on the bottom surface of the light guide plate by printing. The printed material directs light to emit from the front side and evenly distributes on the light emission area. The non-printing approach is to form a design pattern of a mold core, and the light guide plate is formed by injection by using the mold core to generate the pattern on the light guide plate. Light may be directed for emitting through the front surface to distribute evenly on the light emission area. The non-printing approach can achieve greater stability, quality and improved accuracy, and thus has become the main stream of the present manufacturing method.

The methods for fabricating the mold core of the light guide plate generally have two types: one uses an etching process to directly print patterns on the mold core, another one fabricates the mold core with high precision patterns (about dozens of μm) through a semiconductor manufacturing process (exposing and image developing). Refer to FIGS. 1 to 6 for the prior arts that fabricate a light guide plate mold core 6 through the semiconductor manufacturing process. It includes coating photoresist 2 on a glass substrate 1 (referring to FIG. 1); forming a photoresist pattern on the glass substrate 1 by exposing and developing through a photomask 3 of a selected pattern (referring to FIGS. 2 and 3); coating evenly a metal layer 4 on the surface of the glass substrate 1 by vaporizing or sputtering process (referring to FIG. 4); depositing a layer of metal base 5 on the metal layer 4 by electroform (referring to FIG. 5); and separating the glass substrate 1 and the photoresist 2 from the metal layer 4 to form the light guide mold core 6 with the pattern formed on the surface (FIG. 6).

The foregoing method has drawbacks, such as the time taken to depositing the metal base 5, and low yield. Electroform process produces an uneven surface on the metal base 5 and a secondary machining process is required. The process is complicated and tedious.

### SUMMARY OF THE INVENTION

It is an object of the present invention to provide a method for manufacturing light guide plate mold cores that has a simple fabrication process, can save time, and requires less material and is suitable for mass production.

The method according to the invention includes forming a non-metallic layer with a selected pattern on the surface of a metal substrate, forming a metal layer on the surface of the metal substrate that is not covered by the non-metallic layer at a thickness not greater than the non-metallic layer by electroplating or electroless plating, removing the non-metallic layer, and finally forming a surface layer on the surfaces of the metal substrate and the metal layer by electroless plating to form a light guide plate mold core.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional fabrication process 1;

FIG. 2 is a schematic view of a conventional fabrication process 2;

FIG. 3 is a schematic view of a conventional fabrication process 3;

FIG. 4 is a schematic view of a conventional fabrication process 4;

FIG. 5 is a schematic view of a conventional fabrication process 5;

FIG. 6 is a schematic view of a conventional fabrication process 6;

FIG. 7 is a schematic view of a fabrication process 1 according to the invention;

FIG. 8 is a schematic view of a fabrication process 2 according to the invention;

FIG. 9 is a schematic view of a fabrication process 3 according to the invention;

FIG. 10 is a schematic view of a fabrication process 4 according to the invention;

FIG. 11 is a schematic view of an exposing and developing process 1 according to the invention;

FIG. 12 is a schematic view of an exposing and developing process 2 according to the invention.

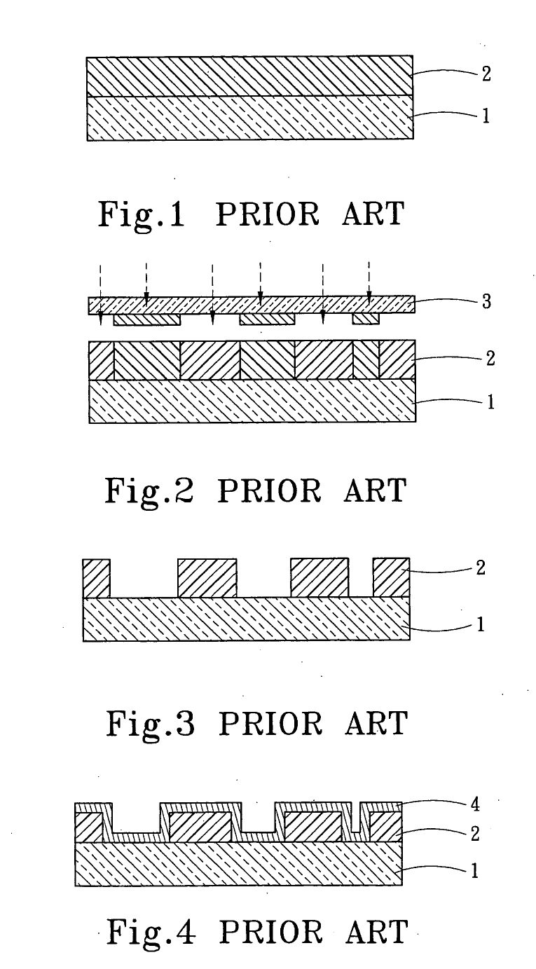

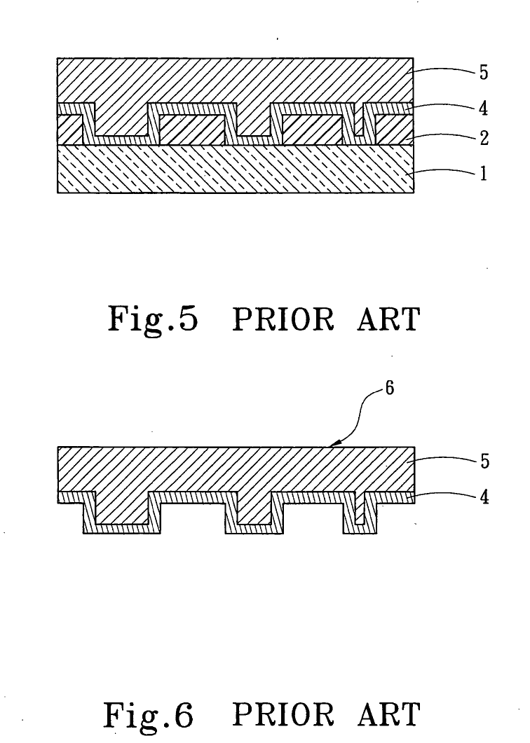

### DETAILED DESCRIPTION OF THE INVENTION

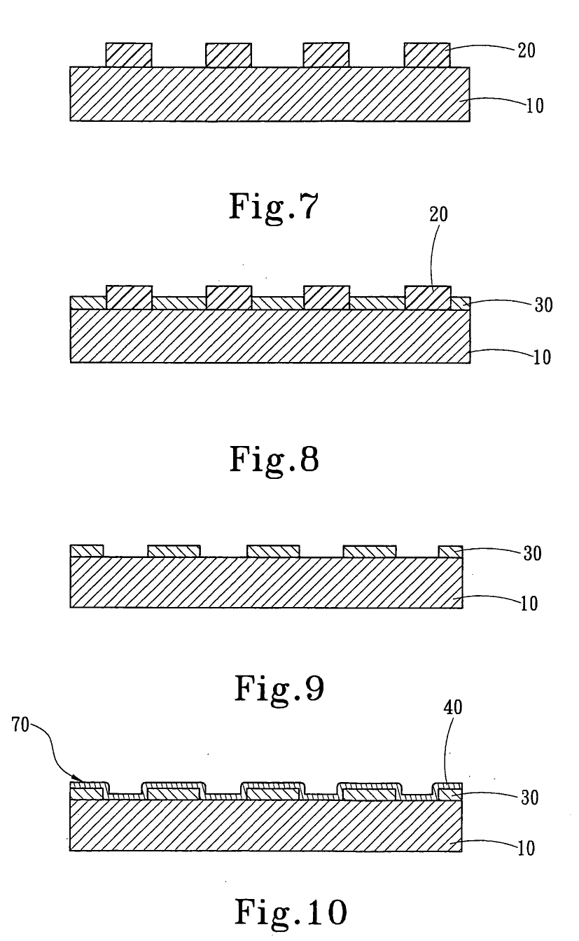

Please refer to FIGS. 7 to 10 for the method according to the invention, which details the following steps:
(a) Forming a non-metallic layer 20 of a selecting pattern on the surface of a metal substrate 10 (referring to FIG. 7) by a micro lithography process.
(b) Forming a metal layer 30 (FIG. 8) on the surface of the metal substrate 10 that is not covered by the non-metallic layer 20 at a thickness not greater than the non-metallic layer 20 by electroplating or chemical plating. The metal layer is deposited only on the metal substrate 10 not covered by the non-metallic layer 20, and does not cover the non-metallic layer 20 when its thickness is not greater than the non-metallic layer 20. Many types of metal may be used in the electroplating or electroless plating process and the process is well developed. The commonly used ones include electroplated nickel, non-electrolyzed nickel non-electrolyzed copper and plating of other metals and the like.
(c) Removing the non-metallic layer 20 (FIG. 9) by using a cleaning solution. The cleaning solution can dissolve the non-metallic layer 20 but has no reaction with the metal layer 30 and the metal substrate 10. It can be water or an etching solution.
(d) Forming a surface layer 40 (FIG. 10) on the surface of the metal substrate 10 and the metal layer 30 by electroless plating. The metal used in the electroless plating are non-electrolyzed nickel, non-electrolyzed iron and so on. The electroless plating is to submerge the article to be plated in a chemical agent to generate replacement reaction or oxidized reduction to separate out metal ions on the product surface from the metal compound solution.

By means of the above-mentioned process, the metal substrate 10 with a desired profile of varying heights (pattern) is covered by a surface layer 40. As the surface layer 40 is a nickel-phosphorus alloy formed by plating the non-electrolyzed nickel, its surface is smoother, abrasion-resistant and corrosion-resistant. Thus, it can be used as the light guide plate mold core 70.

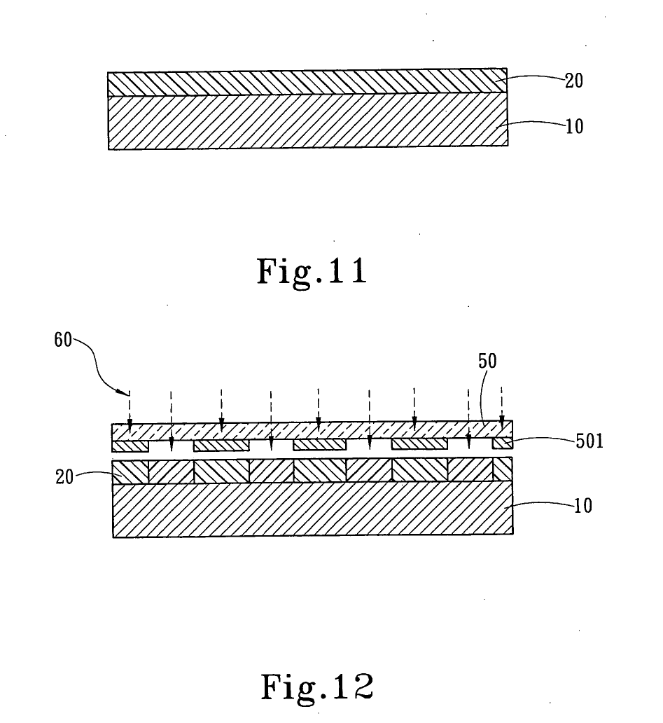

At the step (a), an exposing and developing method is used to form the non-metallic layer 20 of a selecting pattern on the surface of the metal substrate 10. Referring to FIG. 11, first, coating a photoresist layer (non-metallic layer 20) on the metal substrate 10; covering a photomask 50 that has opaque portions 501 (referring to FIG. 12) on the metal substrate 10 coated with the photoresist layer (non-metallic layer 20); irradiating light 60 (generally ultra-violet light) on the unmasked portion of the photoresist layer (non-metallic layer 20) to cure the exposed photoresist layer (non-metallic layer 20); etching the photoresist layer with a developing solution to form the photoresist layer (non-metallic layer 20) of a selected pattern on the metal substrate 10 (referring to FIG. 7).

The present invention has a more simplified manufacturing process than conventional techniques. In the conventional techniques, the glass substrate must be removed at the final step, and forming a thick metal base by electroform deposition takes a lot of time. The present invention does not use the glass substrate, and does not need to deposit the metal base, thus can save material and simplify the manufacturing process.

It will be obvious to those having skill in the art that many changes may be made to the details of the above-described embodiments of this invention without departing from the underlying principles thereof. The scope of this invention should, therefore, be determined only by the following claims.

1. A method for manufacturing light guide plate mold cores, comprising steps of:
(a) forming a non-metallic layer of a selected pattern on a surface of a metal substrate;
(b) forming a metal layer on the surface of the metal substrate that is not covered by the non-metallic layer at a thickness not greater than the non-metallic layer;
(c) removing the non-metallic layer; and
(d) forming a surface layer on the surfaces of the metal substrate and the metal layer.

2. The method according to claim 1, wherein the non-metallic layer is a photoresist layer.

3. The method according to claim 2, wherein the step (a) includes coating a photoresist layer on the metal substrate, and forming a selected pattern on the photoresist layer on the metal substrate by exposing and developing processes.

4. The method according to claim 1, wherein the step (b) includes forming the metal layer by electroplating or electroless plating.

5. The method according to claim 1, wherein the step (c) includes using an etching solution or water to remove the non-metallic layer.

6. The method according to claim 1, wherein the step (d) includes using electroless plating to form the surface layer.

7. The method according to claim 6, wherein the electroless plating uses a metallic material which includes non-electrolyzed nickel or non-electrolyzed iron.
